(19) United States
(12) Patent Application Publication
(10) Pub. No.: US 2023/0129991 A1
(43) Pub. Date: Apr. 27, 2023

(54) SYSTEMS AND METHODS FOR USE IN BIOMETRIC-ENABLED NETWORK INTERACTIONS

(71) Applicant: MASTERCARD INTERNATIONAL INCORPORATED, Purchase, NY (US)

(72) Inventors: Florent Hay, Laeken (BE); Eddy Van De Velde, Leuven (BE); Patrik Smets, Begijnendijk (BE)

(21) Appl. No.: 17/970,466

(22) Filed: Oct. 20, 2022

Related U.S. Application Data
(60) Provisional application No. 63/271,068, filed on Oct. 22, 2021.

(51) Int. Cl. G06Q 20/40; G06Q 20/38

(52) U.S. Cl. CPC G06Q 20/40145; G06Q 20/3825

(57) ABSTRACT

Systems and methods are provided for facilitating biometric-enabled network interactions. One example computer-implemented method includes receiving, at a biometric identity switch, from a terminal associated with a party, a request for an enrollment of a biometric of a user for biometric-enabled network interactions, the request including a biometric template of the user, identifying a biometric service provider associated with the biometric template, requesting from the identified service biometric provider, a biometric identifier for the user, based on the biometric template, receiving the biometric identifier from the identified biometric service provider, and then storing the biometric identifier for the user in a user profile, whereby the user is enrolled for biometric-enabled network interactions using the biometric.

### CROSS-REFERENCE TO RELATED APPLICATION

This application claims the benefit of, and priority to, U.S. Provisional Application No. 63/271,068, filed Oct. 22, 2021. The entire disclosure of the above application is incorporated herein by reference.

### FIELD

The present disclosure is generally directed to systems and methods for use in biometric-enabled network interactions and, more particularly, for enrolling users to enable such biometric network interactions via biometric readers.

### BACKGROUND

This section provides background information related to the present disclosure which is not necessarily prior art.

Users are known to initiate interactions with parties in various manners. For example, a user (e.g., a consumer, etc.) may present a physical card, or other device to a merchant party to thereby provide a numeric credential (e.g., a number, a token, etc.) to the merchant party and initiate an interaction with the merchant party, whereby the interaction is funded by an account associated with the numeric credential (and physical card or other device).

### DRAWINGS

The drawings described herein are for illustrative purposes only of selected embodiments and not all possible implementations, and are not intended to limit the scope of the present disclosure.

FIG. 1 is an example system of the present disclosure suitable for use in enrolling a user in biometric-enabled network interactions, via a biometric reader disposed at and/or associated with a first party (e.g., a merchant, etc.);

FIG. 2 is a block diagram of a computing device that may be used in the example system of FIG. 1;

FIG. 3 is an example method, which may be implemented in connection with the system of FIG. 1, for use in identifying a user to a biometric identity switch in connection with enrolling the user in biometric-enabled network interactions; and

FIG. 4 illustrates an example method, which may be implemented in connection with the system of FIG. 1, for use in enrolling a biometric of a user so that the biometric of the user may be used in biometric-enabled network interactions.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

When users interact with parties (e.g., merchants, etc.) to initiate transactions for products (e.g., goods, services, etc.), the users may pay for the products with payment accounts. In doing so, the users are required to present cards or other payment devices (e.g., virtual wallets, etc.), or to enter specific information (e.g., account numbers, etc.), to identify the payment accounts to the parties. The presentation of the cards or other devices, or the entry of the account numbers, is generally cumbersome to both the users and parties, especially where such cards or virtual wallets, for example, are not available or not functional, or account numbers are not readily known without reference to the payment devices, etc. Such use of physical cards or other devices may also present a security risk, as the cards or other devices may be lost or stolen.

Uniquely, the systems and methods herein provide for enrollment of users for biometric-enabled interactions, to link accounts to biometrics of the users, whereby the accounts are identified by parties, through presentation of the biometrics by the users. In particular, a party, such as a merchant, may coordinate obtaining a biometric of a user (e.g., using a biometric reader associated with a biometric service provider (BSP), etc.) for enrollment and subsequent biometric identification (e.g., for using biometric services as described herein such as in-store payments, etc.), while a centralized biometric identity switch (BIS) facilitates the enrollment, and additionally, functions as a repository for the underlying data and controls for subsequent biometric-enabled network interactions (e.g., in a user profile including one or more accounts of a user, etc.). In particular, the BIS facilitates enrollment by determining the BSP associated with the biometric (e.g., based on a biometric template as received from the party/merchant, etc.) and obtaining a biometric identifier for the user from the BSP, based on the biometric (e.g., where the biometric identifier is not the biometric in whole or part, etc.). In addition, several merchants may rely on the BIS to enable and/or aid in biometric-enabled network interactions, for example, regardless of the BSP associated with the given merchant, the biometric reader used by the given merchant, and/or the protocol used to create the biometric template (e.g., standard, proprietary, etc.). Subsequently, an account of the user may be identified by the involved parties, in connection with the BIS and the user profile stored thereby, based on presentation of a biometric of the user. In this way, the systems and method herein provide an efficient solution for enrolling users in biometric-enabled network interactions, where accounts are linked to biometrics of the users, such that the accounts may be easily identified by parties/merchants, through presentation of the biometrics of the users.

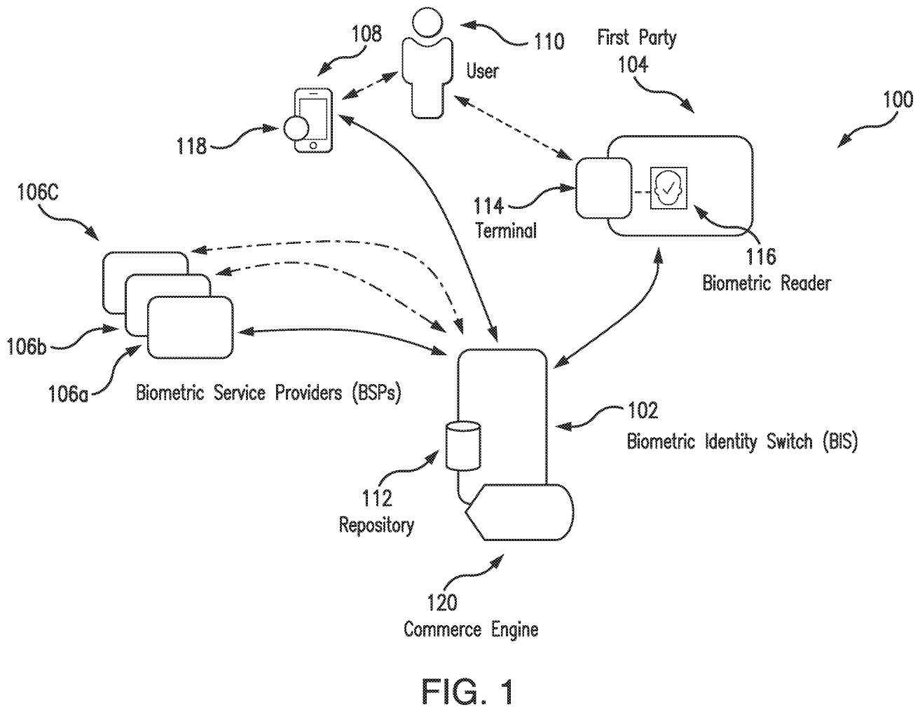

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between users, biometric service providers, and parties; data privacy requirements and/or regulations; etc.

The system 100 generally includes a biometric identity switch (BIS) 102, a first party 104 (e.g., a merchant, another party, etc.), multiple biometric service providers (BSPs) 106a-c (broadly, biometric providers), and a mobile device 108 (associated with a user 110), each of which is coupled in communication via one or more networks (e.g., as indicted by the arrowed lines, etc.). The one or more networks may each include one or more of, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

In this example embodiment, the BIS 102 is configured to perform operations related to biometric interactions associated with the first party 104, for example. Also in this example embodiment, the BIS 102 is illustrated as a standalone party (e.g., an independent service, etc.) in the system 100. In connection therewith, the user 110 (and other users) may enroll his/her payment account(s) (and/or payment card(s)) from any desired payment network (e.g., from Mastercard®, Visa®, Amex®, domestic schemes, etc.) and still use the services of the BIS 102 with regard to biometric interactions. What's more, in some examples, the BIS 102 may be operated by and/or associated with a particular payment network (such as, for example, the Mastercard® payment network, etc.) while still enabling biometric interactions for payment accounts/payment instructions from other payment networks. That said, in such examples, the BIS 102 will generally be separate (e.g., physically, etc.) from the payment network by which it is operated (e.g., to facilitate enrollment of payment accounts (and/or payment cards) from different payment networks, etc.). However, it is contemplated that in some example embodiments, the BIS 102 may be incorporated into a payment network or into another party, such as, for example, a digital identity provider (IDP), a financial institution, or other related or suitable party, etc. In fact, in one particular embodiment, the BIS 102 may be incorporated, in whole or in part, in the Mastercard® payment network, etc. Further, it should be appreciated that the BIS 102 may be implemented to provide features of the present disclosure apart from payments. For instance, the BIS 102 may be configured to perform operations related to biometric interactions in connection with loyalty accounts, age verification scenarios, etc.

As shown, the BIS 102 includes a repository 112, which in this example embodiment is configured to store at least one data structure of user profiles and/or other data, as described in more detail below. For example, the BIS 102 may be configured to store in the repository 112 (although it is not required in all embodiments) user biometrics and/or other user information for the user 110 and other users (e.g., for a limited period of time for dispute purposes, for longer periods of time such as a duration of enrollment of the users, etc.), etc. In connection therewith, and as will also be described in more detail herein, the BSPs 106a-c may also be responsible for keeping reference biometrics for the users, and for returning biometric identifiers (e.g., Bio IDs, etc.) (e.g., which are not biometrics in whole or part, etc.) based on given biometric templates, where the repository 112 of the BIS 102 is configured for keeping a consolidated repository of such data (e.g., biometric settings, links to services such as payments, etc.). In various embodiments, such separation of responsibilities and private data may ensure that user privacy is protected across the system 100, etc. Further, in some embodiments, the repository 112 may also be separate from the BIS 102, whether physically or logically.

In the example embodiment of FIG. 1, the first party 104 includes a merchant (referred to hereinafter as merchant 104) configured to offer products (e.g., goods, services, etc.) for sale to users (e.g., including user 110, etc.) and to sell products to users. The merchant 104, in this example, is disposed at one or more physical locations, whereby users (e.g., including user 110, etc.) are physically present at the merchant 104 when interacting with the merchant 104. It should be appreciated that the merchant 104 may include a physical store (e.g., including various products, etc.), a physical kiosk (e.g., a product dispenser, etc.), or even a virtual storefront to interact with users, etc. It should further be appreciated that the first party 104 may be otherwise in other embodiments (e.g., other than a merchant, etc.), including, for example, a financial institution, another type or business or agency, etc., at which a user may desire to identify a specific payment account linked to a biometric for one or more purposes, etc. What's more, it should be appreciated that, in some example embodiments, the first party 104 may include non-financial and/or non-commerce entities (e.g., non-merchant entities, etc.). In

As shown, the merchant 104 includes a point of sale (POS) terminal 114 (broadly, terminal 114), which, among other things, is configured to receive payment account data, and then compile and transmit authorization messages, via payment networks, to issuers, for payment account transactions funding the purchase of products (e.g., goods, services, etc.) from the merchant 104 (e.g., via authorization schemes, etc.). In particular, for example, for a transaction by the user 110 at the merchant 104, the terminal 114 for the merchant 104 is configured to compile an authorization request (e.g., an ISO 8583 message, etc.), which includes a merchant ID for the merchant 104, a terminal ID for the terminal 114, a transaction amount, a payment account number (e.g., a primary account number (PAN), etc.) (or token) for a funding account of the user 110, an acquirer ID, a date/time, etc., and to then transmit the authorization request to an issuer (not shown) of the user's account, via an acquirer (having the acquirer ID) associated with the merchant 104 and a payment network (not shown). Moreover, the authorization request may further include chip data, including a cryptogram, etc. (e.g., consistent with contact and contactless payment technology as defined by EMVCo (see, e.g., www.emvco.com, etc.), or otherwise, etc.). The issuer is configured, in turn, to respond with an authorization reply indicating whether the transaction is approved or declined. When approved, the purchase is completed with the user 110, and the payment network is configured to clear and settle the transaction between the acquirer and the issuer.

While FIG. 1 illustrates the terminal 114 disposed at the merchant 104, it should be appreciated that the terminal 114 may be a fixed terminal at the merchant 104, or may be a mobile terminal at the merchant 104, or even a terminal disposed away from the merchant 104. For example, the terminal 114 may include a mobile terminal that includes a smartphone, or other portable communication device, etc.

In connection with the above, the terminal 114 is configured, by executable instructions (e.g., a software development kit (SDK), etc.), to communicate with the BIS 102 (e.g., to receive data from the BIS 102, to transmit data to the BIS 102, etc.), whereby the terminal 114 is configured with unique functionality not typically included in POS terminals. In connection therewith, the terminal 114 may be configured to use data received from the BIS 102 (e.g., a data packet or authorization packet, etc.) in connection with compiling and transmitting the authorization request for a transaction (in a manner not conventionally followed by terminals in compiling authorization requests).

Moreover, as shown, the terminal 114 includes, or in this embodiment is connected to, a biometric reader 116 (as indicated by the dashed line in FIG. 1). The biometric reader 116 may include, for example, a camera (e.g., a camera device capable of taking a biometric scan of a face, a hand, a finger, etc.), a fingerprint scanner, a palm scanner, a retina scanner, a voice recorder, a biometric capturing device configured to capture multiple biometrics (or modalities), etc. The biometric reader 116 is configured to capture a biometric (or multiple biometrics) of a user (e.g., the user 110, etc.), when prompted by the terminal 114, to then process the captured biometric(s), through formatting, encryption, etc., and to then return the biometric(s) to the terminal 114 or directly to the BIS 102. It should be appreciated that while only one biometric reader 116 is illustrated in FIG. 1, a different number of biometric readers may be employed in other embodiments. In particular, for different merchants and/or different terminals, the biometric readers may be different, whereby each biometric reader may process captured biometrics differently. For example, a first type of biometric reader 116 may be configured to perform a proprietary encryption, or formatting (e.g., templating, etc.), while a second type of biometric reader may be configured to convert the captured biometric to a standard form, format, or template, etc. What's more, the merchant 104 may include or may be associated with different biometric readers configured to capture different biometrics and implement different formatting, etc. In connection therewith, the BIS 102 may be configured to accommodate both the proprietary formatting and the standard formatting, for example, in a coexisting manner, while also unifying the biometric profiles for users and associated services. That said, in one example embodiment, the biometric reader 116 may be configured to utilize a standard formatting, whereby the BIS 102 may be configured to use a reference template from a first one of the BSPs 106a-c in formatting a biometric captured from the user 110, for example, and pass it to a second one of the BSPs 106a-c (e.g., based on and/or only in response to consent from the user 110, etc.) so that the second one of the BSPs 106a-c may register the user 110 without asking the user 110 to present his/her biometric again. However, in other embodiments, a different biometric template may be captured every time the user enrolls with a different one of the BSPs 106a-c.

Also, while the biometric reader 116 is illustrated as separate from the terminal 114 in FIG. 1, it should be appreciated that it may be included with or integrated, in whole or in part, with the terminal 114 in other embodiments. For example, a camera input device of a smartphone may be a biometric reader 116 integrated in a mobile terminal, consistent with the description herein.

The BSPs 106a-c are each configured to register, directly through the BIS 102, for example, to promote user privacy, or indirectly, users by their biometrics, whereby each of the BSPs 106a-c is configured to receive and store one or more biometric references or templates for a user and a corresponding biometric identifier (Bio ID or bio_ID) (e.g., where the biometric identifier is not a biometric in whole or part, etc.). The BSPs 106a-c, then, are each configured (e.g., as part of a biometric interaction involving a user, etc.) to subsequently receive a biometric from a user (e.g., the user 110, etc.), to match (or verify) the subsequently received biometric to the biometric reference or template (or set of biometric references or templates) stored therein (e.g., in memory, etc. as obtained during enrollment), and to return the biometric identifier associated with the matching biometric reference. What's more, the BSPs 106a-c may be specific to the biometric reader(s) included at the terminal 114, for example, whereby the form, format, encryption, etc. of the biometric from the biometric reader 116, for example, is specific to one of the BSPs 106a-c.

In connection with the BSPs 106a-c, the BIS 102, and more specifically, the repository 112, may include one or more entries for each of the BSPs 106a-c, which is generally associated with a BSP identifier (BSP_ID). The entries may include, in some embodiments, a description of the form, format, encryption, or content of a biometric processed by the BSPs 106a-c (or biometric readers associated with the BSPs 106a-c) (e.g., an entry may include an indication of the user 110, an indication of merchants or other parties authorized by the user 110, and then an indication of the BSP(s) used or associated with the authorized merchants or other parties, etc.), and/or a listing or identification of the merchant(s) or party(ies) which is/are associated with each of the BSPs 106a-c (e.g., that employ biometric readers specific to a given one of the BSPs 106a-c, etc.). In various embodiments, the repository 112 may include more or less data related to the BSPs 106a-c. In this way, the BIS 102 may identify particular ones of the BSPs 106a-c with which to communicate based on given biometrics, formatting, etc. received from the merchant 104 and other parties. That said, in other embodiments, the biometric reader 116 and/or merchant 104 (and/or terminal 114) may directly provide to the BIS 102 the BSP identifier to which the biometric identification request should be routed (e.g., based on the biometric, based on the formatting, based on the merchant 104, etc.), whereby the such information need not be maintained in the repository (or other database) and to allow for flexibility in the merchant 104 using multiple of the BSPs 106a-c.

In still other embodiments, the BIS 102 may identify one of the BSPs 106a-c to route the identification request based on a merchant ID and/or store ID associated with the request/transaction, etc. (e.g., as configured at the BIS level in the repository 112, etc. (e.g., Merchant ID X=BSP Y, etc.), etc.).

With continued reference to FIG. 1, in the illustrated embodiment, the system 100 also includes the mobile device 108, which is specific to the user 110 in this example. The mobile device 108 may include a smartphone, or tablet, or other communication device, etc., associated with the user 110. That said, the present disclosure is not limited to the mobile device 108. For example, in at least one other embodiment, the mobile device 108 may, more broadly, include a computing device, which may or may not be mobile with the user 110 (e.g., a desktop computer, a server, etc. versus a smartphone), whereby the user 110 may be able to manage his/her biometric profile with the BIS 102 via a website, etc.

As shown in the illustrated embodiment, the mobile device 108 includes an application 118 associated with the BIS 102. The application 118 may be specific and dedicated to the BIS 102, or may be associated with another purpose (e.g., a banking application, an identity application, a wallet application, etc.), yet include an SDK or executable instruction sufficient to interact with the BIS 102 and otherwise configure the mobile device 108, as described herein. Generally, the application 118 is downloaded and installed by the user 110, or otherwise present in the mobile device 108. Alternatively, in some embodiments, the application 118 may include a BIS client (e.g., installed and operative at the mobile device 108, etc.) configured to interact with the BIS 102. Further, in some example embodiments, instead of an application, the mobile device 108 may be operable to access a web address or client associated with the BIS 102 through a web browser installed at the mobile device 108, whereby the operations described herein with regard to the application 118 may be achieved via the access to the web browser or client.

In addition, in this example embodiment, the BIS 102 includes a commerce engine 120. The commerce engine 120 is illustrated as part of, or associated with, the BIS 102. However, it should be appreciated that in other embodiments the commerce engine 120 may be a standalone party (e.g., an independent service, etc.), or the commerce engine 120 may be incorporated into another party (with or without the BIS 102), such as, for example, a payment network, a digital identity provider, a financial institution, or other related or suitable party, etc. In one particular example, the commerce engine 120 (e.g., along with the BIS 102, or separate from the BIS 102, etc.) may be incorporated, in whole or in part, in the Mastercard® payment network, for example, as a secure remote commerce (SRC) service, etc. In general, the commerce engine 120 is configured to, among other things, store payment account data for users (e.g., as part of a cloud wallet, etc.), associate the payment account data with specific identifiers, receive identifiers associated with users (e.g., from the BIS 102, etc.), and return payment account credentials (e.g., from a cloud wallet for the user 110, etc.) for use in an authorization packet for a transaction initiated by the user 110 (e.g., as part of enrollment of the user 110, as a subsequent interaction after enrollment of the user 110, etc.), as described more below. As such, in various embodiments, it should be appreciated that the BIS 102 and the commerce engine 120 may perform one or more of the features described herein independent of the other (e.g., the BIS 102 may provide features of the present disclosure (e.g., relating to age verification, etc.) apart from interaction with the commerce engine 120, etc.).

In this example embodiment, when the user 110 desires to enroll for biometric-enabled interactions, or as otherwise referred to herein as biometric payment, the user 110 accesses the application 118, at the mobile device 108.

In turn, the mobile device 108, as configured by the application 118, is configured to initiate enrollment of the user 110 with the BIS 102 for a new user account or new user profile (e.g., a new biometric profile, etc.). As part of this enrollment process, the BIS 102 is configured to set up a profile for the user 110 (as a new user, etc.), for example, within the repository 112. In connection therewith, the BIS 102 is configured to correlate a user identifier (or consumer identifier or consumer ID) for the user 110 (e.g., a phone number, an email address, another identifier (specifically generated or randomly generated, etc.) assigned to or provided to the user, etc.) to the user profile, whereby the user 110 (represented by the user identifier) and user profile are linked. As such, the user profile for the user 110 may be attached to the user identifier, and the user profile may then include all user data and configuration parameters for the biometric identification provided herein (e.g., a list of services allowed when using biometric identification, a list of payment instruments available for use with biometric identification (such as cards, etc.), a list of merchants available for use with biometric identification, an indication of a default payment instrument for each allowed merchant, etc.)

In connection therewith, the BIS 102 is configured to validate the user profile with the user 110 (e.g., based on a one-time password, etc.). The BIS 102 is also configured to enroll one or more payment instruments of the user 110 (e.g., a card associated with a payment account, etc.) in the user profile. The BIS 102 is further configured to identify particular parties (e.g., merchant 104, etc.) to the user profile, for example, whereby the user 110 is able to subsequently engage in biometric-enabled network interactions with the party(ies). In doing so, the BIS 102 is optionally configured to solicit rules and/or limitations from the user 110 for the biometric-enabled network interactions that are specific to a payment instrument included in the user profile and/or a party identified in the user profile (e.g., particular payment instruments may be available for use with only particular services (e.g., payment, loyalty, etc.), biometric identification may only be available at particular merchants for use with particular services (e.g., payment, loyalty, etc.) etc.). Still further, the rules and/or limitations may relate to periods or times when biometric identification may or may not be used (e.g., biometric identification may not be available during times when the user 110 is at work, etc.). Moreover, in some examples, use of biometric identification may be activated and deactivated (e.g., turned on or turned off, etc.) as desired by the user 110, for example, via the application 118, depending on when the user 110 desires to use biometric identification.

Once the user profile is created for the user 110, when the user 110 desires to enroll a biometric for use with the user profile in the repository 112, for example, the user 110 may enroll with one or more parties (e.g., the merchant 104, etc.), and in doing so, with one or more of the BSPs 106a-c, and also with the BIS 102, to allow for use of the biometric in biometric-enabled network interactions as described herein. In doings so, the user 110 may have an option to enroll a particular biometric (e.g., a finger print, a palm print, etc.), but not others (e.g., not facial images, iris scans, etc.) Further, the user 110, for example, may have an option to enroll the biometric via a kiosk in-store at one or more parties (e.g., at the terminal 114 at the merchant 104, etc.), and/or via application 118 (e.g., in the user's mobile device 108, etc.).

Initially, in this example embodiment, the user 110 requests to enroll the biometric via the application 118, and then provides the biometric via the terminal 114 of the merchant 104. In response to the request (e.g., in response to selection of an option to request enrollment of the biometric at the application 118, etc.), the mobile device 108, as configured by the application 118, is configured to encrypt the user identifier of the user 110 (as previously assigned by the BIS 102 and associated with the user profile for the user 110 (e.g., where the user identifier generally includes the user's phone number, email address, other data generated by the BIS 102 (e.g., an assigned identifier generated by the BIS 102, etc.) as part of the prior enrollment of the user with the BIS 102) (e.g., using a public key of a key pair of the BIS 102, etc.) and encode the encrypted user identifier into a computer-readable indicia (e.g., a QR code, etc.). The mobile device 108 is configured to then display the computer-readable indicia, such that the user 110 may present the indicia to the merchant 104, and specifically, to the terminal 114. Alternatively, the BIS 102 may be configured to randomly generate a number (broadly, an identifier) (e.g., data generated by the BIS 102 based on a prior interaction of the user 110 with the BIS 102, etc.) in response to selection by the user 110, via the application 118, to enroll at the terminal 114 and provide the same to the application 118. And, the mobile device 108, as configured by the application 118, is configured to encode the encrypted number into a computer-readable indicia and present the indicia to the merchant 104, and specifically, to the terminal 114.

The terminal 114 is configured to read, capture, etc. the computer-readable indicia and obtain (e.g., decode, etc.) the encrypted user identifier therefrom (or the randomly generated number) (again, each broadly an identifier). In response, the terminal 114 is configured to direct the biometric reader 116 to capture and to return a biometric from the user 110 (a default biometric, a biometric specified by the user 110, etc.). In turn, the biometric reader 116 is configured to, in response, capture the requested biometric (e.g., fingerprint, facial image, etc.) and process the captured biometric. In this example embodiment, the processing includes generating a biometric template from the captured biometric, encrypting the biometric template based on a public, private, or potentially, proprietary encryption scheme, and appending an identifier of a BSP associated with the biometric reader 116 (e.g., one of the BSPs 106a-c, etc.). In addition (or alternatively), the processing may include appending an identifier associated with a model or type of the biometric reader 116 or specific to the biometric reader 116 (whereby one or more of the BSPs 106a-c may be identified based on the identifier), and may also include formatting and/or size reduction operations in connection with templating, etc. Then, after processing the biometric (e.g., into an encrypted biometric template, etc.), the biometric reader 116 is configured to provide the encrypted biometric template, including the appended identifier(s), back to the terminal 114.

The terminal 114 is configured to transmit the encrypted biometric template to the BIS 102, along with the encrypted user identifier (from the decoded computer-readable indicia) (or along with the randomly generated number from the BIS 102), as part of a request to enroll the provided biometric of the user 110 in the user profile (where the user profile of the user 110 is identified based on the encrypted user identifier, or where the user profile of the user 110 is identified based on the BIS 102 reconciling the randomly generated number with the user identifier). The BIS 102 is configured to then identify a one of the BSPs 106a-c associated with the received biometric template and/or to identify a uniform resource locator (URL) (and/or a server address) for the BSP (e.g., from multiple URLs associated with the BSP where each URL may be associated with a different terminal, merchant, party, group of terminals, group of merchants, group of parties, etc.) associated with the received biometric template, based on one or more entries (or mappings) in the repository 112. In one implementation, the entry for each of the BSPs 106a-c identifies each merchant and/or other party from which a biometric is to be received, along with a listing of the BSP for the party. Table 1 below illustrates an example data structure. In such an implementation, the BIS 102 is configured to identify one of the BSPs 106a-c (or associated URL) based on the identifier(s) of the party/merchant/terminal and/or name of the party/merchant/terminal from which the biometric template is received, and as included in the biometric enrollment request (e.g., as appended to the biometric template, etc.).

TABLE 1

| Party | Biometric Service Provider |
|---|---|
| Merchant 104 | BSP 106a |
| Merchant A | BSP 106c |
| Terminal 123456 | URL of BSP 106b |
| Party X | BSP 106a |
| Merchant B | BSP 106a |
| Party Y | BSP 106b |

Once the appropriate one of the BSPs 106a-c is identified, the BIS 102 is configured to transmit the biometric enrollment request to the identified BSP. The identified one of the BSPs 106a-c is configured to receive the request from the BIS 102. Upon receipt of the biometric enrollment request, the identified one of the BSPs 106a-c is configured to store the biometric data included in the request in memory (e.g., as a biometric reference, etc.) and assign a biometric identifier thereto. The identified one of the BSPs 106a-c is configured to then provide the biometric identifier to the BIS 102 (linked, for example, with the biometric based on the computer-readable indicia provided with the encrypted biometric template, etc.).

The BIS 102 is configured to receive the biometric identifier from the one of the BSPs 106a-c, and in response, to store the biometric identifier in the user profile of the user 110 (e.g., within the repository 112, etc.). In connection therewith, as generally indicated above, the BIS 102 is configured to decrypt the user identifier received from the terminal 114 (from the decoded computer-readable indicia) (e.g., using a private key of the key pair of the BIS 102, etc.). Alternatively, where the computer-readable indicia provided from the mobile device 108 to the terminal 114 includes the randomly generated number, the BIS 102 may be configured to reconcile the randomly generated number with the user identifier. In either case, the user identifier is then used to identify the user 110, and the user profile of the user 110 (for storing the biometric identifier received from the one of the BSPs 106a-c).

In some example embodiments, as part of enrollment, the user 110 may provide multiple different biometrics to the biometric reader 116 sufficient to support a biometric PIN. In turn, the biometric PIN may be used to authenticate the user 110 in a transaction performed at the merchant 104 in combination with such enrollment.

Thereafter, enrollment of the biometric of the user 110 is complete and available for use by the user 110 and/or the merchant 104 in connection with subsequent biometric-enabled network interactions at the merchant 104 (and, potentially, at other merchants and/or other parties). In connection therewith, the BIS 102 is configured to notify the user 110 (e.g., via a notification presented at the mobile device 108 via the application 118, etc.) and/or the merchant 104 (e.g., via a notification received at the terminal 114, etc.) that enrollment of the biometric is complete. In one or more implementations, prior to completion of enrollment of the biometric of the user 110, the BIS 102 is configured to generate a merchant-specific user token (e.g., specific to the merchant 104, etc.), based on the user profile, whereby the merchant 104 is able to identify the user 110 based on the merchant-specific user token in connection with subsequent biometric-enabled network interactions. In such embodiments, the BIS 102 is configured to provide the merchant-specific user token to the merchant 104, as part of the notification indicating enrollment of the user's biometric is complete.

Based on the foregoing, the system 100 is configured to complete enrollment of the biometric for the user 110, whereby the BIS 102 is configured to subsequently facilitate biometric-enabled network interactions involving the user 110 and the merchant 104 (e.g., a biometric pay interaction, a loyalty interaction, etc.) based on creation of the user profile for the user 110 and the enrollment of the biometric of the user 110 (as received from the merchant 104, etc.).

While enrollment of the user 110 and enrollment of the biometric of the user 110 for biometric-enabled interactions is generally described above as taking place through the BIS 102, such enrollment may occur otherwise in other embodiments. For example, in some embodiments the user 110 may enroll for biometric-enabled interactions through the merchant 104, and the merchant 104 may then be configured to push (or pass) enrollment data to the BIS 102, for the BIS 102 to then compile a user profile for the user 110, to add a biometric ID to the user's profile, etc. Or, the merchant 104 may be configured to generate the user profile for the user 110 and then coordinate use thereof by the BIS 102 as desired (potentially providing generic enrollment for the user 110 for multiple merchants, etc.).

In any case, after enrollment of the user's biometric is complete and in connection with a network interaction at the merchant 104, the terminal 114 is configured to direct the biometric reader 116 to capture and to return a biometric from the user 110. In turn, the biometric reader 116 is configured to, in response, capture the biometric (e.g., fingerprint, facial image, etc.) and process the captured biometric, as described above. The biometric reader 116 is configured to transmit the processed biometric to the BIS 102, directly (e.g., via an API exposed by the BIS 102, etc.) or through the terminal 114. Along with the biometric, the BIS 102 may also receive, from the biometric reader 116 and/or the terminal 114, details associated with the interaction (e.g., amount, date, type of transaction, etc.), details associated with the merchant 104 (e.g., merchant ID, store ID (e.g., to locate where the user 110 is performing the interaction and narrow the list of biometric IDs, etc.), etc.), and details associated with the terminal 114 (e.g., terminal type, currency code, category code, etc.), etc.

In turn, the BIS 102 is configured to then identify one of the BSPs 106a-c (or associated URL) associated with the received biometric, as described above. Once the appropriate one of the BSPs 106a-c is identified, the BIS 102 is configured to transmit the biometric to the identified biometric provider, for example, BSP 106a, as part of a request for a biometric identifier (or biometric ID) of the user 110. The BSP 106a is configured to then compare the biometric to one or more of the biometric references stored at the BSP 106a. When a match is found, the BSP 106a is configured to return a biometric identifier associated with the matching biometric reference to the BIS 102 (e.g., where the biometric identifier is not a biometric (e.g., is not the biometric reference, etc.) in whole or part, etc.).

In turn, the BIS 102 is configured to identify the user profile for the user 110, based on the biometric identifier, and access, retrieve, compile, etc. a data packet (or authorization packet) in connection with the interaction at the merchant 104. In this example embodiment, the BIS 102 is configured to convert the biometric identifier to an identifier associated with the user 110 known to the commerce engine 120 (e.g., a phone number, an email address, an identity token, an identifier associated with an encrypted credential, etc.), for example, via the user profile within the repository 112, and to submit a request for the account credentials (e.g., payment account credentials, loyalty account credentials, etc.) for the user 110, as part of (or for use in) the data packet, to the commerce engine 120. Additionally or alternatively, a masked account identifier of an account of the user 110 may be stored in the user profile (e.g., in connection with adding accounts during enrollment, etc.) and transmitted to the commerce engine 120 to request such account credentials. The commerce engine 120 is configured to receive the request, to access a profile for the user 110 based on the identifier(s) included in the request, and then to retrieve the account credentials (or encrypted credential) and return the same to the BIS 102. Alternatively, in one or more embodiments, the commerce engine 120 may be omitted when the biometric identifier is associated with an encrypted credential.

The BIS 102, then, is configured to compile the data packet for the transaction and provide the same to the merchant 104 (e.g., convert the data packet into a format that is suitable for the terminal 114 and then provide the same to the terminal 114, etc.). Alternatively, the commerce engine 120 may be configured to compile the data packet. Regardless, because the data packet is consistent with the transaction, the packet may include various details of the transaction and the merchant 104, but as a minimum will contain the account credentials of the user 110 sending the transaction. For example, the data packet may include, without limitation, a cryptogram for the transaction, a PAN for the user's account (from the wallet profile for the user 110), a token (or digital PAN) for the user's account (or encrypted credential), chip data for and/or associated with the user's account, cryptographic data allowing the issuer of the user's account to verify a card is a genuine card, and an expiration date for the PAN. The terminal 114 is configured, then, to compile, convert, map, etc. the data packet into an authorization request for the interaction (in an appropriate format) that can be transmitted by the terminal 114 (e.g., to an acquirer for the merchant 104, etc.).

It should be appreciated that, in connection with the above, the BIS 102 may be configured to check any rules and/or limitations defined by the user 110 (e.g., in connection with enrollment for the user profile, etc.) for the account and/or the merchant 104, and implement such rules and/or limitations as applicable, prior to requesting and/or providing the data packet for biometric payment at the merchant 104.

It should also be appreciated that in some example embodiments, the user 110 may enroll at the same time as initiating a network interaction at the merchant 104. In such embodiments, the BIS 102 may use the biometric captured from the user 110 to enroll the user 110 and also retrieve payment credentials directly to facilitate the interaction.

It should also be appreciated that while only one merchant 104 is included in FIG. 1, a different number of merchants, each associated with one of the BSPs 106a-c, may be included in other embodiments. Likewise, a different number of BSPs may be included in other system embodiments.

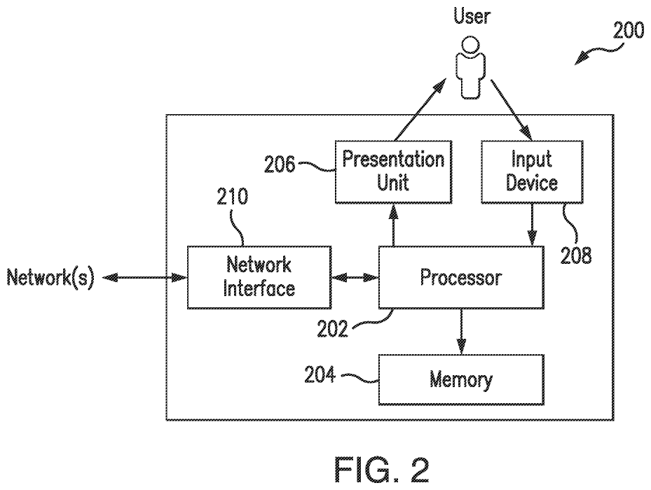

FIG. 2 illustrates an example computing device 200 that can be used in the system 100 of FIG. 1. The computing device 200 may include, for example, one or more servers, workstations, personal computers, laptops, tablets, smartphones, virtual devices, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the BIS 102, the merchant 104 (e.g., the terminal 114, the biometric reader 116, etc.), the BSPs 106a-c, and the commerce engine 120 may include or may be implemented in a computing device consistent with the computing device 200 (coupled to (and in communication with) the one or more networks of the system 100). However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, profiles, rules, biometrics, entries, policies, formatting/encryption algorithms, biometric references, identifiers, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein (e.g., one or more of the operations of method 300, method 400, etc.), such that the memory 204 is a physical, tangible, and non-transitory computer readable storage media. Such instructions often improve the efficiencies and/or performance of the processor 202 and/or other computer system components configured to perform one or more of the various operations herein, whereby upon performance of the same the computing device 200 is transformed into a special purpose computer system. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, visually or audibly, for example, to a user of the computing device 200 (e.g., the user 110, etc.) (e.g., notifications of enrollment, etc.) whereby the information may be displayed at (or otherwise emitted from) computing device 200, and in particular at presentation unit 206. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user of the computing device 200 (i.e., user inputs) such as, for example, selection, biometrics, etc., as further described herein. The input device 208 may include a single input device or multiple input devices. The input device 208 is coupled to (and is in communication with) the processor 202 and may include, for example, one or more of a keyboard, a pointing device, a mouse, a camera, a biometric reader, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), or other device capable of communicating to one or more different networks herein and/or with other devices described herein. Further, in some example embodiments, the computing device 200 may include the processor 202 and one or more network interfaces incorporated into or with the processor 202.

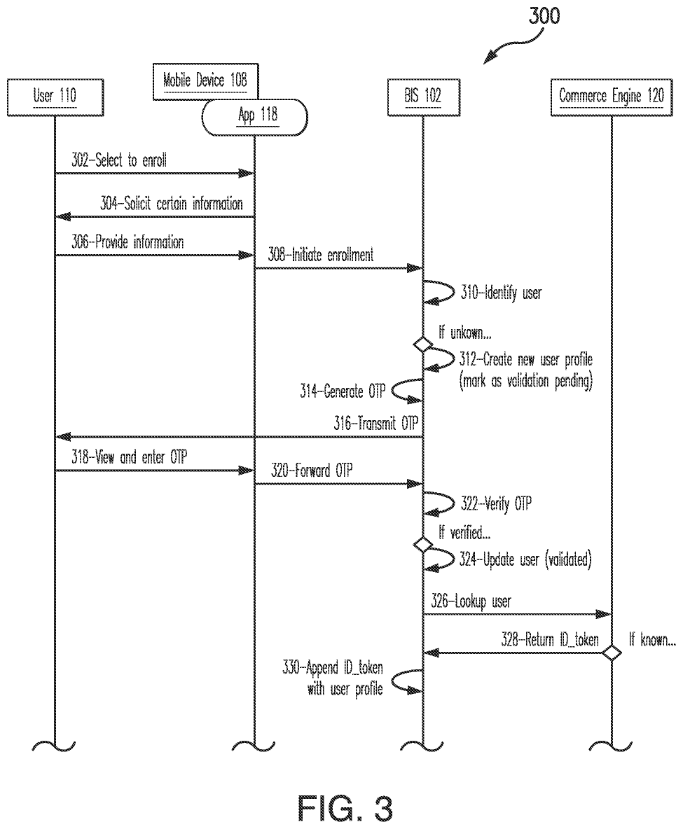

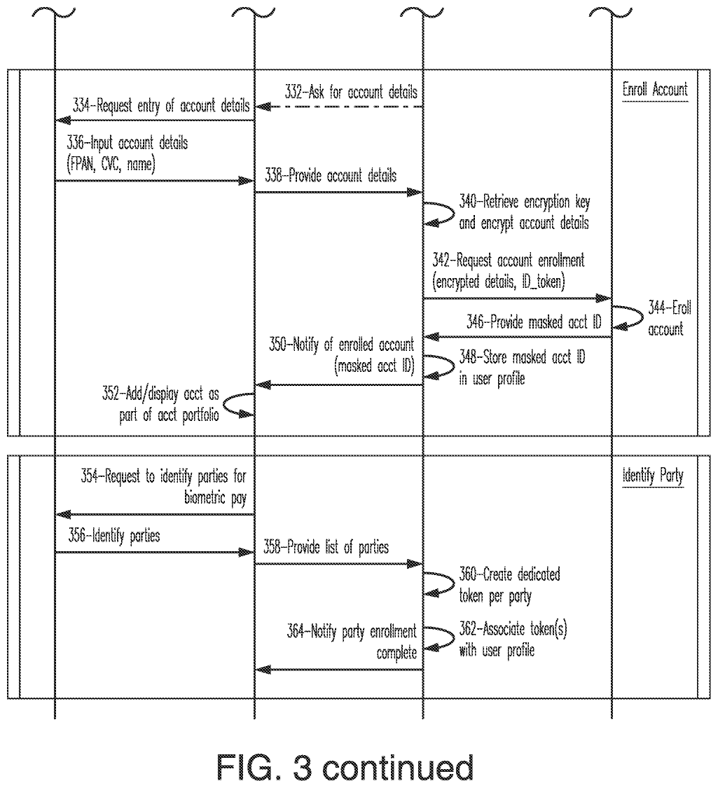

FIG. 3 illustrates an example method 300 for use in enrolling a user to a biometric identify switch (BIS) to enable use of biometric identification as described herein. The example method 300 is described with reference to the BIS 102 and the other parts of the system 100, and also with reference to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

In connection with the method 300, at the outset, the user 110 has already downloaded and installed the application 118 at the mobile device 108. Then, when the user 110 decides to enroll with the BIS 102 (and create a user profile, etc.), the user 110 accesses the application 118 (or potentially a web address associated with the BIS 102 via a browser at the mobile device 108) in the mobile device 108 and selects, at 302, an option to enroll (e.g., for biometric payments, etc.). In turn, the mobile device 108, via the application 118, solicits certain information from the user 110, at 304. In response, the user 110 provides, at 306, the solicited information (e.g., including personal identifying information (PII), etc.) to the mobile device 108, via the application 118. The information may include, for example, a name, email address, phone number, mailing address, etc. of the user 110. What's more, the information may also include a username and password for the user 110 for the new user profile, where the username may be defined by the user 110 or may be the email address of the user 110. In turn, the mobile device 108 initiates, at 308, enrollment of the user 110 with the BIS 102. The initiation may include transmitting some or all of the received information to the BIS 102, along with, potentially, one or more identifiers specific to the mobile device 108 and/or the application 118 (e.g., application ID, ESN, etc.) as additional information.

Upon receipt of the information for the user 110, the BIS 102, at 310, identifies the user 110, based on the information received from the mobile device 108, as either known or unknown. If known, the BIS 102 determines that the user 110 already has a profile, for example, and the method 300 proceeds to later steps as described below (e.g., to step 334, to step 354, etc.). In connection therewith, the BIS 102 may bind the received information with the existing profile. If, however, the user 110 is unknown, as shown in FIG. 3, the BIS 102 creates, at 312, a user profile for the user 110. In particular, the BIS 102 generates a user identifier, which is specific to the user 110, and stores the user identifier and the information received from the mobile device 108 in the user profile in the repository 112. The BIS 102 also marks the user profile as validation pending, indicating that the user profile is created, but not yet validated.

Once the user profile is created, the BIS 102 generates, at 314, a one-time password (OTP) and transmits, at 316, the OTP to the user 110. For example, the BIS 102 may transmit the OTP to the user 110 via an email message, SMS message, or otherwise, etc., generally apart from the application 118. Upon receipt, the user 110 is permitted to view the OTP and then enter the OTP into the application 118 at the mobile device 108, at 318. The mobile device 108 forwards, at 320, the OTP to the BIS 102. Further, in some embodiments, where the OTP is transmitted by the BIS 102 to user 110 as an SMS message, the application 118 may listen on the SMS, parse the SMS when received, extract the OTP, and then automatically provide the OTP to the BIS 102.

With continued reference to FIG. 3, upon receipt of the OTP, the BIS 102 verifies, at 322, the OTP, by a comparison of the generated OTP and the OTP as received from the application 118 at the mobile device 108. If the OTP is verified, the BIS 102 updates, at 324, the user profile from validation pending to validated. If the OTP is not verified, the user profile remains validation pending. In the latter, the BIS 102 may generate and transmit an additional OTP to the user 110, as an additional attempt to validate the user profile. It should be appreciated that the BIS 102 may rely on other methods to validate the user profile. For example, the BIS 102 may transmit an email to the user 110 including a link, whereupon selection of the link by the user 110 permits the BIS 102 to validate the user profile.

Once the user profile is validated, the BIS 102 performs a lookup of the user 110, at 326, with the commerce engine 120. For example, the lookup may be based on any portion of the information included in the user profile. If the user 110 is known by the commerce engine 120, the commerce engine 120 returns, at 328, an identity token (or ID token) specific to the user 110 to the BIS 102. The BIS 102 then appends, at 330, the identity token to the user profile of the user 110 in the repository 112. In connection therewith, the BIS 102 may confirm the enrollment of the user 110 to the mobile device 108 and in doing so, provide the user identifier from the user profile and a public key (associated with a private key of the BIS 102) to the application 118. In turn, the mobile device 108 stores the user identifier and the public key for access by the application 118 in enrolling biometrics to the user's profile, etc. (e.g., as used in method 400, etc.).

Based on the above, a user profile is created for the user 110 and stored in the repository 112. Additionally, the method 300 includes repeatable sub-processes, including a sub-process to enroll an account of the user 110 with the BIS 102 in the user profile for the user 110 and a sub-process to identify parties (e.g., merchant 104, etc.) to the BIS 102 for biometric-enabled network interactions in the user profile. Each of the sub-processes is designated by a box in FIG. 3.

As for the sub-process to enroll an account (e.g., a payment account, a payment instrument, etc.) in the user profile, the BIS 102 optionally (as indicated by the dotted line) requests, at 332, account details for an account from the mobile device 108. The mobile device 108, either initially (e.g., in response to a selection by the user 110 via the application 118 to enroll an account, etc.) or in response to the request from the BIS 102, solicits, at 334, entry of account details for the account from the user 110. In response, the user 110 provides, at 336, the account details to the mobile device 108, via the application 118. The account details may include, for example, a funding primary account number (FPAN), a CVC, a cardholder name, an expiration date, etc. for the account. In particular, the user 110 may enter the account details into the mobile device 108 via the application 118. Alternatively, the user 110 may present a card for the account to the mobile device 108, and using a camera of the mobile device 108 (e.g., camera input device 208, etc.), the mobile device 108 may capture the account details from the card (e.g., by character recognition of an image of a front of the card and/or the back of the card, etc.). It should be appreciated that other methods may be used to provide the account details to the mobile device 108, including, for example, wireless communication (e.g., an NFC “tap” of the card to the mobile device 108, etc.), etc.

In a further alternative, the mobile device 108 may request an encrypted credential from the commerce engine 120, for example, when the account is already on file with and/or known to the commerce engine 120 (e.g., previously enrolled for click and pay service, etc.). In connection therewith, a request for the encrypted card is submitted from the mobile device 108 to the commerce engine 120, where the request includes identification of the user 110 (or the mobile device 108), etc. The commerce engine 120 then responds with the encrypted credential (e.g., an encrypted account number, token, etc.). The mobile device 108 then proceeds with the encrypted credential as the account details, as described herein.

In turn, the mobile device 108 provides, at 338, some or all of the account details to the BIS 102.

In response to the account details, the BIS 102 retrieves, at 340, an encryption key and encrypts the account details using the encryption key. The encryption key may be part of a key pair shared with the commerce engine 120, for example. In turn, the BIS 102 transmits, at 342, a request for enrollment of the account of the user 110 with the commerce engine 120, including the encrypted account details and the identity token for the user 110. Upon receipt of the request, the commerce engine 120 enrolls the account, at 344. In particular, the commerce engine 120 sends a tokenization request for the account to an issuer of the account. The tokenization request may include some or all of the account details and/or the identity token. In connection therewith, upon receipt of approval from the issuer for tokenization, the commerce engine 120 creates a token and generates a masked PAN for the account or other masked card account identifier (or masked account ID). At 346, the commerce engine 120 returns the masked PAN/masked account ID to the BIS 102.

Upon receipt of the masked PAN, the BIS 102 stores, at 348, the masked PAN in the user profile in the repository 112. Additionally, at 350, the BIS 102 notifies the application 118 of the enrolled account. In connection therewith, the BIS 102 transmits the masked PAN to the application 118 for display at the mobile device 108, for example, as part of an account portfolio of the user 110. The mobile device 108 then adds, at 352, the masked PAN to the account portfolio within the application 118, where the enrolled account may be displayed to the user 110. In some embodiments, the account added to the user profile is flagged as the “default” account in the user profile. It should be appreciated that in various embodiments, the account may be added to the user profile, via the masked PAN, in other manners, for example, in connection with a lookup of the user 110 at the commerce engine 120 (e.g., at 322 in method 300, etc.) when an account is already enrolled with the commerce engine 120.

It should be appreciated that the masking steps above may be omitted, or not, in certain embodiments, for example, when the account details include an encrypted credential, in lieu of an account number, expiration date, CVC, etc. It should also be appreciated that when an encrypted credential is employed, in lieu of the account number, expiration date, CVC, etc., the BIS 102 avoids processing or possessing such identifying information, whereby restriction and/or regulations of the BIS 102 may, in some embodiments, be different (e.g., less stringent (e.g., non-PIC compliant, etc.), etc.).

As for the sub-process to identify parties (e.g., merchant 104, etc.) to the BIS 102 for biometric-enabled network interactions in the user profile, the mobile device 108, via the application 118 (e.g., via input by the user 110 to the application 118, etc.), initially requests, at 354, parties for biometric payment to be identified by the user 110. To facilitate this operation, the BIS 102 may submit a list of parties (e.g., merchant locations, etc.) to the user 110, via the application 118, for example, that accept or allow biometric-enabled network interactions (e.g., by leveraging geo-fencing, and then displaying on a map, or using a list, the places that are enabled; etc.). The user 110 then identifies, at 356, the party(ies) (e.g., merchant 104, other merchants, etc.) to the mobile device 108, via the application 118, for which biometric payment is to be available. In connection therewith, the user 110 may enter various rules or limitations on biometric payment at the parties, for example, a limitation on a maximum amount for biometric payments, use rules, etc. At 358, the mobile device 108 provides the list of the party(ies) (and optionally any rules or limitations associated with each party) to the BIS 102.

Upon receipt of the list, the BIS 102 creates, at 360, a dedicated token for each party included in the list (e.g., a time-limited token that is only active for a limited amount of time (e.g., 12 hours, etc.), etc.). In connection therewith, each token is a token or tokenized version of the user ID that is specific to the party. The BIS 102 then associates, at 362, the token(s) with the user profile within the repository 112 (e.g., stores the token(s) in the user profile, etc.), and notifies the mobile device 108, at 364, that enrollment of the party(ies) is complete. The token(s) may be used for a variety of different purposes related to the user profile. For example, a token included in the user profile (and specific to a merchant) may be provided to the merchant for loyalty purposes (e.g., as a loyalty account identifier, etc.), for purchase purposes, for receipt purposes, etc.

In addition, optionally, although not shown in FIG. 3, the user 110 may add a PIN to the user profile (through the application 118, etc.), for storage in the user profile within the repository 112. In particular, the mobile device 108, via the application 118, may prompt the user 110 to define a PIN for use in transactions and the user 110 enters a desired PIN value. Next, the mobile device 108, via the application 118, may prompt the user 110 to re-enter the PIN value. After the user 110 re-enters the PIN value into the application 118, the mobile device 108, via the application 118, may determine whether both entries from the user 110 contain the same PIN value. When the PIN entries do not contain the same PIN value, the mobile device 108, via the application 118, may prompt the user 110 to re-define the PIN and enter a new PIN value. However, when the first and second PIN entries match, the mobile device 108, via the application 118, may encrypt the PIN using a public key (associated with a private key of the BIS 102) and transmit the encrypted PIN to the BIS 102. In turn, the BIS 102 may store the PIN in a secure manner as part of the user profile within the repository 112. After the PIN is stored, the mobile device 108, via the application 118, may notify the user 110 that the PIN has been successfully setup. The PIN may then be used in connection with biometric payments as a second factor authentication to confirm the identity of the user 110 (e.g., when a low confidence score is associated with a biometric verification of the user 110, when regulations require a second authentication factor to perform in-person transactions, etc.).

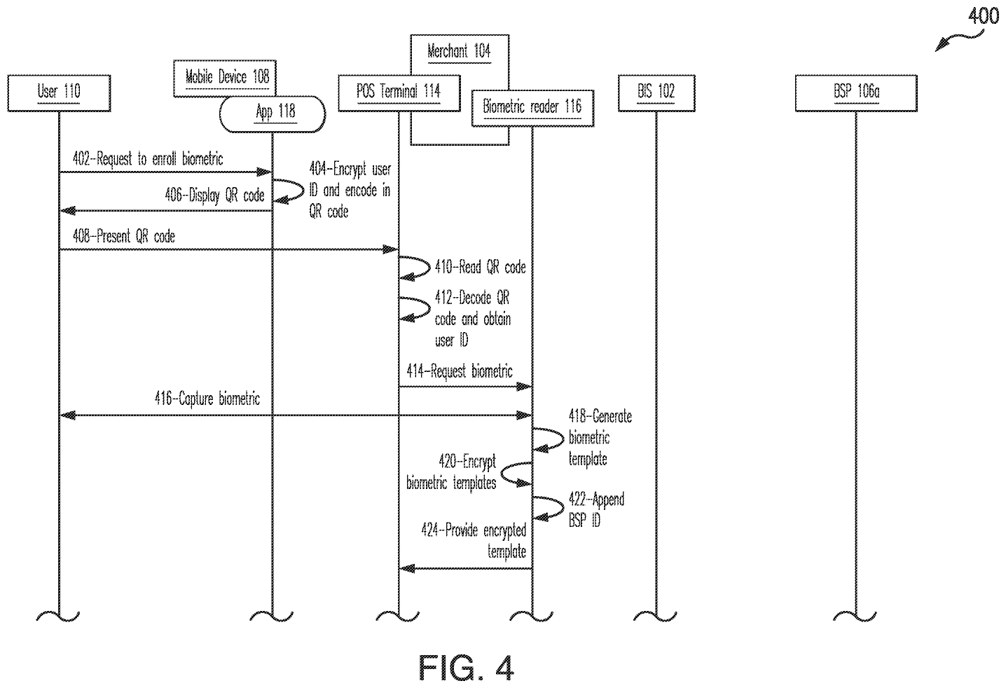

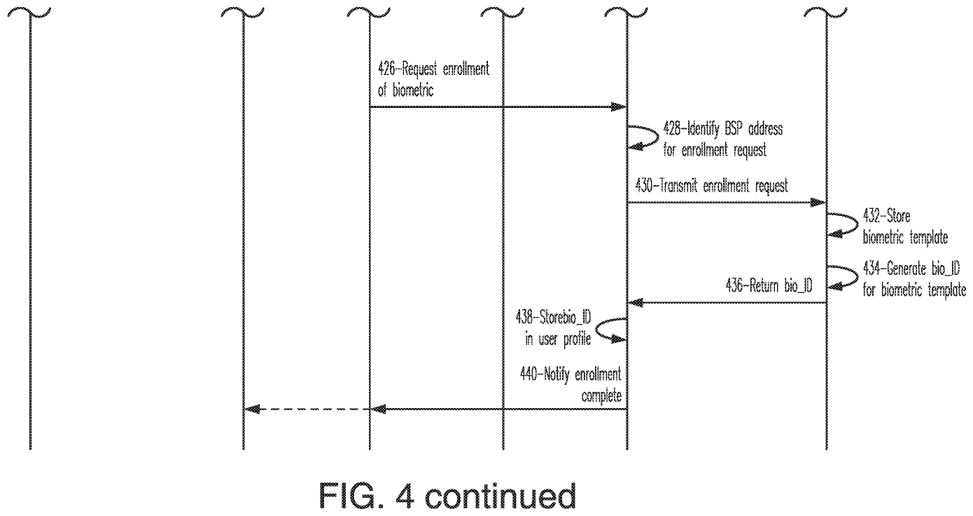

FIG. 4 illustrates an example method 400 for use in enrolling a biometric of a user, so that the biometric may be used in biometric-enabled network interactions. The example method 400 is described with reference to the BIS 102 and the other parts of the system 100, and also with reference to the computing device 200. However, the methods herein should not be understood to be limited to the system 100 or the computing device 200, as the methods may be implemented in other systems and/or computing devices. Likewise, the systems and the computing devices herein should not be understood to be limited to the example method 400.

Subject to the method 300, or parts thereof, when the user 110 desires to enroll a biometric for use with his/her user profile in the repository 112, the user 110 requests, at 402, to enroll the biometric with the application 118. In response, at 404, the mobile device 108, via the application 118, encrypts the user identifier and encodes the encrypted user identifier into a computer-readable indicia, such as, for example, a QR code or barcode or other code, etc. The encryption of the user identifier may be based, for example, on the public key (of the public-private key pair from the BIS 102). Alternatively, as described above, the BIS 102 may provide (or generate) a random number to the application 118 (broadly, an identifier or data generated by the BIS 102), and the application 118 may then encode the random umber into a computer-readable indicia, such as, for example, a QR code or barcode or other code, etc. In turn, the mobile device 108 displays the QR code, for example, at 406 (e.g., via a presentation device 206 of the mobile device 108, etc.). The user 110 presents, at 408, the QR code to the POS terminal 114 of the merchant 104, and the POS terminal 114 reads, at 410, the QR code. In response, the POS terminal 114 of the merchant 104 decodes, at 412, the QR code and obtains the encrypted user identifier therefrom (or random number generated by the BIS 102).

In this example embodiment, a computer-readable indicia is used for communication between the user and the POS terminal 114 with regard to the user identifier (or random number). However, it should be appreciated that other methods or operations may be used to provide the user identifier (or random number) to the merchant 104, including, for example, wireless communication (e.g., an NFC “tap” of the mobile device 108 at the POS terminal 114, etc.), etc.

Next, the POS terminal 114 requests, at 414, a biometric of the user 110 be captured by the biometric reader 116. At 416, the biometric reader 116 captures the biometric of the user 110. For example, the biometric reader 116 may include a camera input device 208 which captures an image of the user 110 (facial image). As another example, the biometric reader 116 may include a fingerprint scanner input device 208 which captures a fingerprint of the user 110. Other suitable input devices may be employed, as needed, to capture the biometric requested.

It should be appreciated that multiple biometrics may be captured by the biometric reader, in a specific order and/or sequence, as a biometric PIN for the user 110. Specifically, for example, the user 110 may be prompted, by the POS terminal 114 or the biometric reader 116 to present (for capture) a specific biometric for a number (e.g., 4, 5, 8, etc.), and then to present the biometrics in a specific order to indicate a PIN associated with the user 110 and/or an account to be used for payment, which may be verified in connection with an enrollment and payment. That is, the biometric PIN may provide a second authentication factor to improve security and/or ensure the user 110 is a legitimate user of the BIS account, whereby credentials could be retuned to the merchant 104 (e.g., at step 440, etc.). It should be understood that other forms of a second authentication factor may be integrated into the method 400 in other examples.

With reference again to FIG. 4, upon capture of the biometric, the biometric reader 116 generates, at 418, a biometric template based on the captured biometric. It should be appreciated that the biometric template may be generated by the biometric reader 116 according to a variety of protocols. For example, the biometric reader 116 may generate the biometric template according to a standard protocol, whereby a standard biometric template is produced. Alternatively, the biometric reader 116 may generate the biometric template according to a proprietary protocol, for example, where the proprietary protocol is specific to the type of input device used by the biometric reader 116 to capture the biometric (e.g., specific to the camera input device 208, the fingerprint scanner input device 208, etc.) and/or specific to one or more of the BSPs 106a-c associated with the biometric reader 116.

With continued reference to FIG. 4, the biometric reader 116 encrypts, at 420, the biometric template. For example, the biometric template may be encrypted based on a key specific to the BIS 102 and/or a key specific to the one of the BSPs 106a-c associated with the biometric reader 116 (e.g., BSP 106a). In one example embodiment, the biometric template is encrypted based on a key specific to the BSP 106a. In this example embodiment, then, the BIS 102 may download public keys of all of the BSPs 106a-c (as supported by the BIS 102) to the application 118 (and/or to the terminal 114 and/or the biometric reader 116). In turn, the public key related to the BSP 106a, in this example, capturing the customer biometric template, may be used to encrypt the biometric template. In this way, in this example, the BIS 102 is not allowed access to plaintext user biometrics at any time, even though BIS 102 is in communication with the BSPs 106a-c, etc.

Thereafter in the method 400, the biometric reader 116 appends, at 422, an identifier of the BSP 106a associated with the biometric reader 116 (e.g., a BSP ID for BSP 106a, etc.) to the encrypted biometric template. Additionally or alternatively, the biometric reader 116 may append an identifier associated with a model or type of the biometric reader 116 or specific to the biometric reader 116 and/or an identifier specific to the key used to encrypted the biometric template (whereby one or more BSPs 106a-c may be subsequently identified, for example, by the BIS 102, etc. based on the model/type identifier and whereby the key for decrypting the biometric template may be identified based on the key identifier). In still other embodiments, the biometric reader 116 may append other data relating to the biometric reader 116 and/or relating to a type of the captured biometric and/or relating to a formatting of the biometric template whereby the BIS 102 may subsequently use such data to identify the appropriate one of the BSPs 106a-c.

In turn, the biometric reader 116 provides, at 424, the encrypted biometric template, including the identifier(s), to the POS terminal 114. And, the POS terminal 114 requests, at 426, enrollment of the biometric of the user 110 with the BIS 102. The biometric enrollment request may include at least the encrypted biometric template and the identifier(s) as well as the encrypted user identifier of the user 110 (and/or random number provided by the BIS 102) (e.g., from the decoded computer-generated indicia, etc.). Upon receipt of the request, the BIS 102 identifies, at 428, the BSP 106a associated with the biometric reader 116 and/or a uniform resource locator (URL) (and/or a server address) for the BSP 106a (e.g., from multiple URLs associated with the BSP 106a where each URL may be associated with a different terminal, merchant, party, group of terminals, group of merchants, group of parties, etc.) associated with the received biometric enrollment request, based on the identifier(s), such that the biometric enrollment request may be addressed to the BSP 106a. In connection therewith, the BIS 102 also decrypts the user identifier included in the biometric enrollment request (e.g., using the private key of the key pair of the BIS 102, etc.) (and/or uses the random number previously generated) and identifies the user 110 as associated with the request. The BIS 102 then transmits, at 430, the biometric enrollment request to the BSP 106a. Alternatively, in some embodiments, the biometric reader 116 may directly address the biometric enrollment request to the BSP 106a (e.g., without involvement of the POS terminal 114 and/or the BIS 102 in routing the request to the BSP 106a, etc.).

Upon receipt, the BSP 106a stores, at 432, the biometric template from the received biometric enrollment request and generates, at 434, a biometric identifier (or bio_ID) for the template. For example, the BSP 106a creates an entry for the user 110 (e.g., in a database associated with the BSP 106a, etc.) and stores the biometric template and the biometric identifier within the entry for the user 110 (e.g., to associate the biometric identifier with the biometric template of the user 110, etc.). Thereafter, the BSP 106a returns, at 436, the biometric identifier to the BIS 102. The BIS 102 then stores, at 438, the biometric identifier of the user 110 in the user profile within the repository 112. Additionally, the BIS 102 may store an identifier of the BSP 106a in association with the biometric identifier of the user 110 in the user profile.

The BIS 102 may also generate, in some embodiments, a merchant-specific user token that uniquely identifies the user 110 for the merchant 104 based on the user profile (e.g., based on some or all of the data included in the user profile, such as the biometric identifier of the user 110, etc.). For example, this token may be used by the merchant 104 in connection with subsequent biometric payments involving the user 110 at the merchant 104. At 440, the BIS 102 notifies the merchant 104 (e.g., via the POS terminal 114, etc.) that enrollment of the biometric of the user 110 is complete, whereby the user 110 is able to participate in biometric-enabled network interactions with the merchant 104. As part of the notification to the merchant 104, the BIS 102 provides the user token to the merchant 104. In addition, optionally (as indicated by the dotted line in FIG. 4, as part of step 440), the BIS 102 also notifies the user 110 (e.g., via the application 118 of the mobile device 108, etc.) that enrollment of the biometric of the user 110 is complete.

In view of the above, the systems and methods herein provide enrollment for users for biometric-enabled network interactions (e.g., biometric pay, loyalty programs, etc.) at a merchants. In particular, the merchants may coordinate obtaining the biometrics (e.g., using biometric readers associated with biometric service providers (BSPs), etc.) for enrollment, while relying on the BIS to facilitate the enrollment with particular ones of the BSPs, and additionally, may operate as a repository for the underlying data and controls for subsequent biometric-enabled network interactions (e.g., in user profiles including one or more accounts of the users, etc.). In addition, several merchants may rely on the BIS to enable and/or aid in biometric-enabled network interactions, for example, regardless of the BSPs associated with the merchants, the biometric readers used by the merchants, and/or the protocols used to create the biometric templates (e.g., standard, proprietary, etc.). The systems and method herein thus provide an efficient solution for biometric-enabled interactions, to link accounts to biometrics, whereby the accounts are identified by parties, through presentation of the biometrics.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the recited steps and/or operations of the claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for enrolling biometrics of users for use in biometric-enabled network interactions, the method comprising:
receiving, at a biometric identity switch (BIS) computing device, from a terminal associated with a party, a request for an enrollment of a biometric of a user for biometric-enabled network interactions, the request including a biometric template of the user;
identifying, by the BIS computing device, a user profile for the user based on a first identifier included in the request;
identifying, by the BIS computing device, a biometric service provider associated with the biometric template;
requesting, by the BIS computing device, from the identified biometric service provider, a biometric identifier for the user, based on the biometric template;
receiving, by the BIS computing device, the biometric identifier from the identified biometric service provider; and
storing, by the BIS computing device, the biometric identifier for the user in the identified user profile for the user, whereby the biometric of the user is enrolled for use in biometric-enabled network interactions.

2. The computer-implemented method of claim 1, further comprising notifying, by the BIS computing device, the party at the terminal that enrollment of the biometric of the user is complete, after storing the biometric identifier in the user profile.

3. The computer-implemented method of claim 1, wherein the request further includes a second identifier appended to the biometric template, the second identifier indicative of the biometric service provider, the party, and/or a biometric reader associated with the biometric template; and
wherein identifying the biometric service provider includes identifying the biometric service provider based on the second identifier.

4. The computer-implemented method of claim 1, further comprising:
generating, by the BIS computing device, a token specific to the party, as part of the user profile; and
transmitting, by the BIS computing device, the token to the party, whereby the party is permitted to identify the user in connection with a biometric-enabled interaction based on the token.

5. The computer-implemented method of claim 1, further comprising:
receiving, at the BIS computing device, from the terminal, a subsequent biometric template of the user in connection with a network interaction with the party;
identifying, by the BIS computing device, a biometric service provider associated with the subsequent biometric template;
requesting, by the BIS computing device, from the identified biometric service provider, the biometric identifier for the user, based on the subsequent biometric template;
receiving, by the BIS computing device, the biometric identifier from the identified biometric service provider;
determining, by the BIS computing device, an authorization packet for the user based on the biometric identifier and the user profile; and
transmitting, by the BIS computing device, the authorization packet to the terminal.

6. The computer-implemented method of claim 5, wherein the authorization packet includes one or more payment credential for the user for use in the network interaction with the party.

7. The computer-implemented method of claim 1, wherein the biometric template is based on a fingerprint or a facial image of the user.

8. The computer-implemented method of claim 1, wherein the first identifier is encrypted, and wherein the method further includes decrypting the first identifier prior to identifying the user profile for the user based on the first identifier.

9. The computer-implemented method of claim 1, wherein the first identifier includes one of a phone number associated with the user, an email address associated with the user, and data generated by the BIS computing device as part of a prior engagement involving the user.

10. A computer-implemented method for use in enrolling biometrics of users in accounts associated with the users for use of the biometrics in biometric-enabled network interactions, the method comprising:
receiving, by a terminal associated with a merchant, a first identifier from a mobile device associated with a user;
requesting, by the terminal, capture of a biometric of the user at a biometric reader associated with the merchant;
receiving, by the terminal, biometric data of the user from the biometric reader, the biometric data of the user indicative of the biometric; and
requesting, by the terminal, enrollment of the biometric of the user with a biometric identity switch (BIS) computing device, the request including the biometric data of the user for the biometric and the first identifier.

11. The computer-implemented method of claim 10, further comprising:
capturing, by the biometric reader, the requested biometric;
processing, by the biometric reader, the captured biometric;
appending, by the biometric reader, to the processed biometric, a second identifier indicative of a biometric service provider associated with the biometric reader; and
transmitting, by the biometric reader, the biometric data to the terminal, the biometric data including the processed biometric and the second identifier.

12. The computer-implemented method of claim 11, wherein the second identifier includes an identifier specific to the biometric service provider identifier or a merchant identifier specific to the merchant.

13. The computer-implemented method of claim 11, wherein processing the captured biometric further comprises:
generating, by the biometric reader, a biometric template based on the captured biometric; and
encrypting, by the biometric reader, the biometric template.

14. The computer-implemented method of claim 10, further comprising, in connection with a biometric-enabled network interaction involving the user and the merchant, receiving, by the terminal, from the BIS computing device, an authorization packet;
compiling, by the terminal, an authorization request based on the authorization packet; and
transmitting, by the terminal, the authorization request to an acquirer associated with the merchant.

15. The computer-implemented method of claim 10, wherein the first identifier includes an encrypted identifier associated with the user.

16. The computer-implemented method of claim 10, further comprising:
generating, by the BIS computing device, a token specific to the party, as part of a user profile for the user; and
transmitting, by the BIS computing device, the token to the terminal, whereby the party is permitted to identify the user in connection with a biometric-enabled interaction based on the token.

17. The computer-implemented method of claim 10, wherein the first identifier is included in a computer-readable indicia; and
wherein receiving the first identifier includes:
reading, by the terminal, the computer-readable indicia from the mobile device; and
decoding, by the terminal, the first identifier from the computer-readable indicia.

18. The computer-implemented method of claim 10, wherein receiving the first identifier includes receiving, by the terminal, the first identifier via wireless communication with the mobile device.

19. A non-transitory computer-readable storage medium comprising executable instructions for use in biometric-enabled network interactions, which when executed by at least one processor of a biometric identity switch (BIS) computing device, cause the at least one processor to:
receive, from a terminal associated with a party, a request for an enrollment of a biometric of a user for biometric-enabled network interactions, the request including a biometric template of the user;
identify a user profile for the user based on a first identifier included in the request;
identify a biometric service provider associated with the biometric template;
request, from the identified biometric service provider, a biometric identifier for the user, based on the biometric template;
receive the biometric identifier from the identified biometric service provider; and
store the biometric identifier for the user in the identified user profile for the user, whereby the biometric of the user is enrolled for use in biometric-enabled network interactions.
